(19) United States
(12) Patent Application Publication
(10) Pub. No.: US 2008/0256708 A1
(43) Pub. Date: Oct. 23, 2008

(54) Cot for Patient

(76) Inventor: Sin-Taek Park, Mokpo (KR)

Correspondence Address: LADAS & PARRY LLP, 224 SOUTH MICHIGAN AVENUE, SUITE 1600, CHICAGO, IL, 60604, US

(21) Appl. No.: 11/596,244

(22) PCT Filed: Apr. 28, 2005
(86) PCT No.: PCT/KR2005/001229

§ 371 Date: Nov. 13, 2006

(30) Foreign Application Priority Data
May 15, 2004 (KR) 10-2004-0034554

(51) Int. Cl. A61G 7/02; A61G 7/015; A61G 9/02

(52) U.S. Cl. 5/605; 5/604

(57) ABSTRACT

The present invention is related to a bed, and more particular, related to a bed for patient having a bedpan and a disrobing means. In the bed for patient provided with a bedpan device under a bedstead supporting a mattress according to the present invention, a bedpan hole is formed on the upper part of a portion in which the bedpan is installed, and a shielding means for hiding the hip and private parts of patient is installed on a side of the bedpan hole.

### TECHNICAL FIELD

The present invention is related to a medical bed, and more particular, related to a bed for a patient, which is used by a disabled or inconvenient patient.

The present invention is further related to a bed for patient, in which a shielding means is installed on the upper part of a bedpan device to hide the hip and the private parts of patient, thereby the patient can ease nature without shame. Moreover, even though the patient relieves himself/herself in laying down state, splashing of urine is blocked by a shielding piece.

Furthermore, the present invention is related to a bed for patient, which has a bedpan device, and a disrobing means to make the patient take off his trousers and relieve oneself with easy.

### BACKGROUND ART

As a movement of an inconvenient or disabled patient is restricted, a nurse should be need. If the nurse is away from the patient, the patient suffers difficulty for relieving himself/herself.

In order to overcome the problem mentioned above, a bedpan was installed under a bed. In case of installing the bedpan under the bed, there is a problem that the patient cannot ease nature with comfortable, as evacuation in the bedpan is not immediately treated, and a stench would be produced from the evacuation.

Further, in the bed equipped with a conventional bedpan, there is a problem that the patient relieves himself/herself in laying down state, or in sitting state by the nurse. Thus, the patient cannot ease nature by himself/herself.

### DISCLOSURE OF INVENTION

### Technical Problem

Therefore, the present invention is devised to overcome the above problems, and an object of the present invention is to provide a bed for patient having a bedpan device which has a flushing function to prevent a stench from being produced from evacuation, and to put excreted evacuation in an evacuation container to close the evacuation container for preventing a stench.

Further, other object of the present invention is to provide a bed for patient, by which the lower part inconvenient patient can take off trousers and ease nature by himself/herself, the patient can ease nature with a comfortable posture as the patient ease nature with sitting posture and the lower part of body being shielded with a sheet, and the patient can ease nature without shame and wash evacuation as a shielding means for shielding the lower part of body and a washing device are equipped.

Furthermore, another object of the present invention is to provide a bed for patient, in which a patient can take a rest and a sleep with comfortable as the washing device and the shielding means enter and leave the bed through the floor under the bed.

### Technical Solution

Therefore, the present invention is devised to overcome the above problems, and an object of the present invention is to provide a bed for patient having a bedpan device which has a flushing function to prevent a stench from being produced from evacuation, and to put excreted evacuation in an evacuation container to close the evacuation container for preventing a stench.

Further, other object of the present invention is to provide a bed for patient, by which the lower part inconvenient patient can take off trousers and ease nature by himself/herself, the patient can ease nature with a comfortable posture as the patient ease nature with sitting posture and the lower part of body being shielded with a sheet, and the patient can ease nature without shame and wash evacuation as a shielding means for shielding the lower part of body and a washing device are equipped.

Furthermore, another object of the present invention is to provide a bed for patient, in which a patient can take a rest and a sleep with comfortable as the washing device and the shielding means enter and leave the bed through the floor under the bed.

### ADVANTAGEOUS EFFECTS

As the bed for patient according to the present invention is provided with the flushing function, cleanness of the hip and the private parts of the patient is maintained, and as evacuation in the bedpan is easily discharged, a stench is prevented from being produced.

Further, as the disrobing means is provided to the present invention, the lower part inconvenient patient can take off trousers and ease nature by himself/herself, the patient can ease nature with a comfortable posture as the patient ease nature with sitting posture as well as laying down posture, and the patient can ease nature without shame and wash evacuation as a cobra-shaped shielding means for shielding the lower part of body and a washing device are equipped. Further, a patient can take a rest and a sleep with comfortable as the washing device and the shielding means enter and leave the bed through the floor under the bed.

### BRIEF DESCRIPTION OF THE DRAWINGS

FIG. 1 shows constitution of a bed for patient according to the present invention;

FIG. 2 is a perspective view of bedstead frames of a bed for patient according to the present invention;

FIG. 3 is a side view of a folded mattress of a bed for patient according to the present invention;

FIG. 4 is a side view of a spread mattress of a bed for patient according to the present invention;

FIG. 5 is a plane view of a bed for patient according to the present invention;

FIG. 6 is a perspective view of a folded mattress installed on a bed for patient according to the present invention;

FIG. 7 is a perspective view showing assembling of an opening/closing means for opening/shutting a bedpan opening of a bed for patient according to the present invention;

FIG. 8 is a partial perspective view of one embodiment of a wastewater container of a bed for patient according to the present invention;

FIG. 9 is a cross-sectional view of the wastewater container in FIG. 8;

FIG. 10 is a perspective view of one embodiment of a disrobing means installed on a bed for patient according to the present invention;

FIG. 11 is a cross-sectional view taken from line B-B in FIG. 10;

FIG. 12 is a cross-sectional view of a trousers hanger transporting frame of the disrobing means in FIG. 10;

FIG. 13 is a perspective view of one embodiment of a shielding means installed on a bed for patient according to the present invention;

FIG. 14 is a perspective view of other embodiment of a shielding means installed on a bed for patient according to the present invention;

FIG. 15 and FIG. 16 are cross-sectional views illustrating operation of the shielding means in FIG. 14;

FIG. 17 is a side cross-sectional view of the shielding means in FIG. 14;

FIG. 18 is an enlarged cross-sectional view of A portion in the shielding means in FIG. 14;

FIG. 19 is a perspective view of a injection nozzle and a driving means used in the shielding means in FIG. 14; and

FIG. 20 is a diagram illustrating a spread shielding means when a patient ease nature with laying down a bed for patient according to the present invention.

### BRIEF DESCRIPTION OF REFERENCE NUMBER

100: a bedstead 200:a disrobing means 300:a bedpan means
400:a control box 500:a shielding means
110:a mattress 111:a back part 112:a hip supporting part
113:a leg supporting part 114:a foot supporting part 111a: a fixed hinge axis
113a,114b: a moveable hinge axis 112b,114a:a folding means
112a: a bedpan opening 120: a mattress folding means 121:a first cylinder
122:a second cylinder 123: a hinge plate 130: a mattress supporting frame
131: an edge supporting frame 132: a horizontal frame 133: a vertical frame
133a,133b: axes moving grooves 134:a wheel
210: a trousers hanger transporting frame 211: a trousers hanger moving hole
212:a trousers hanger 213: a connection string 230: a motor 214a:a bevel gear
215,215:a pulley 216: a trousers hanger transporting belt
217,217,234:a stop switch 220: a frame supporting means
221: a transporting frame hole 240: a moving-up and down axis
250: a moving-axis supporting frame 260: a frame transporting belt
310:a bedpan 321:a water-supply pipe 331: a bedpan cover
332: a motor 333: a pinion 334:a rack 335:a connecting rod
336:a hinge rod 337: projection 338:a guide 338a,338b: guide grooves
341: a wastewater container 341a: an outer protecting container
341b: an inner creased container 341c:an outflow pipe 341d:an inflow pipe
341e: a moving plate 341f: a grip 342:an outflow pipe 343:a 3-way valve
351:a housing 351a:a water-supply pipe 351b:an arc-shaped rack
352:a shielding piece housing 352a:a water-supply pipe insertion part
352b: a housing step 352c:a driving plate stop-step 352d:a hose
353:a shielding piece 353a:a hinge axis 353b:a spring
353c:a rotating projection part 354:a D.C. motor 354a:a pinion
355:a first shock-absorbing spring 356:a moving means
356a:a second shock-absorbing spring 357:a stop switch
358: a shielding piece driving means 358a:a step
358c: a shielding-piece rotating means 359: a water-supply hose
360:a spring shock-absorber 370: a housing fixing frame
410:a D.C. motor 420:an eccentric pulley 430:a wire
440:an injection nozzle 441: an injection hole

### BEST MODE FOR CARRYING OUT THE INVENTION

The object of the present invention is accomplished by a bed for patient having a bedpan means installed on the lower part of the bed, the bed supporting a mattress thereon. An opening is formed on the upper part of a portion of the bed having the bedpan means installed, and a shield means for shielding the hip and the private parts of a patient is installed on a side of the opening.

The present invention will now be described in detail in connection with preferred embodiments with reference to the accompanying drawings.

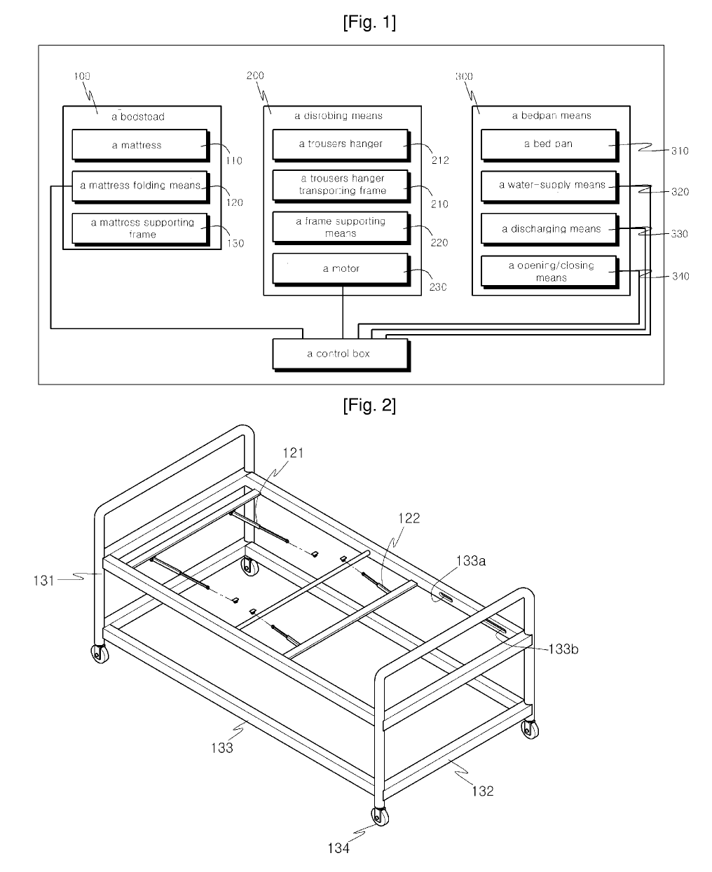

FIG. 1 shows a structure of a bed for patient according to the present invention.

As will be seen from FIG. 1, the bed for patient comprises a bedpan means 300. A shield means 500 for shielding the hip and the private parts of a patient is installed on the upper part of the bedpan means 300.

The bed for patient further comprises 100, a disrobing means 200 and a control box 400.

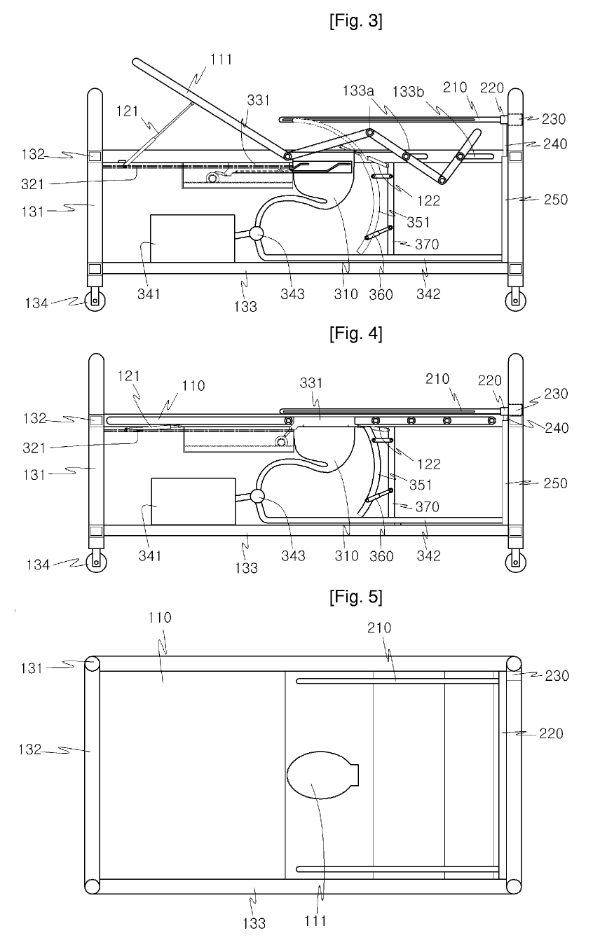

The bedstead 100 includes a mattress 110, a mattress supporting frame 130 and a mattress folding means 120. As shown in FIG. 3 6, the mattress 110 includes a back part 111, a hip supporting part 112, a leg supporting part 113 and a foot supporting part 114. All of the parts are foldably joined with a hinge.

The back part 111 and the hip supporting part 112 of the mattress 110 are rotatably inserted in a hinge hole through a fixed hinge axis 111a, the hinge hole being formed on the inside of a vertical frame 133 of frames making up the mattress supporting frame 130.

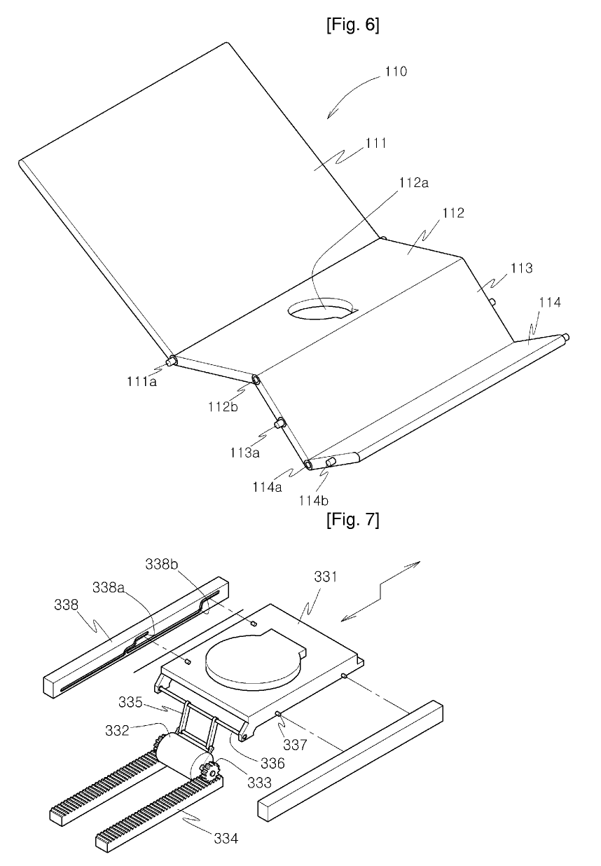

Thus, the back part 111 and the hip supporting part 112 is folded centering around the hinge axis 111a as shown in FIGS. 3 and 6, or is spread as shown in FIG. 4.

Portions between the hip supporting part 112 and the leg supporting part 113, and the leg supporting part 113 and the foot supporting part 114 are foldably connected through folding means 112b and 114a. That is, when a patient is in a position for easing nature, as shown in FIG. 3, the folding means 112b is lifted up, and the hip supporting part 112 is tilted in right upward direction and the leg supporting part 113 is tilted in right downward direction in figure to support comfortably the fleshy inside of the thigh and the calf. Further, the folding means 114a is lifted down, and the foot supporting part 114 and the leg supporting part 113 is tilted with an angle similar to that of the foot of patient.

As will be seen from FIG. 3, a moveable hinge axis 113a installed on the leg supporting part 113 is positioned on a portion inclined to the folding means 114a, that is the middle of the leg supporting part 113. Thus, the height of the folding means 112b is equal to the height of the end of the foot supporting part 114 to support and lift up the middle and one end of a trousers hanger transporting frame 210 at the same time.

Moveable hinge axes 113a and 114b are installed on the middle of the leg supporting part 113 and one end of the foot supporting part 114, respectively.

As shown in figures, each part of the mattress 110 is tilted to comfort a patient for easing nature, as the moveable hinge axes 113a and 114b are inserted and laterally moved in the inside of axes moving grooves 133a and 133b formed in the inside of the vertical frame 133 of the mattress supporting frame 130.

A mattress folding means 120 for folding the mattress 110 is installed in order to comfort the patient for easing nature.

As shown in FIG. 2, the mattress folding means 120 is comprised of two cylinders 121 and 122.

The first cylinder 121 of two cylinders 121 and 122 is the means for lifting-up and down the back part 111 of the mattress 110 in order to make the patient sit up against the back part. One end of the first cylinder is rotatably connected to any one of the frames constituting the mattress supporting frame 130, and a piston axis reciprocating in the first cylinder is rotatably connected to a middle portion of the back part 111 through a hinge plate 123.

The second cylinder 122 is the means for folding the hip supporting part 112 centering on the fixed hinge axis 111a. The structure of the second cylinder is the same as that of the first cylinder 121.

As shown in FIG. 2, other devices are easily installed on the center of the bedstead 100, as the first and the second cylinders 121 and 122 are installed on portions adjacent to the vertical frame 133, respectively.

A bedpan opening 112a is formed on the center of the hip supporting part 110 in the mattress 110, and a bedpan 310 is installed under the bedpan opening 112a.

As will be described later, the bedpan 310 is connected to a discharging means 340 to discharge a wastewater having dejection in the bedpan 310.

As shown in FIGS. 3 and 4, one port of 3-way valve 343 is connected to a drainpipe connected to the lower part of the bedpan 310, and the remaining two ports are connected to two pipes, one connected to a wastewater container 341 and the other 342 connected to an outfall.

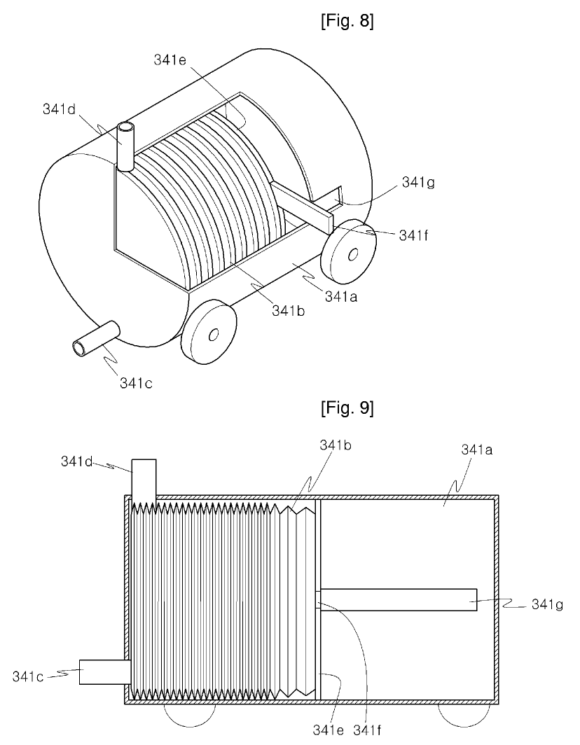

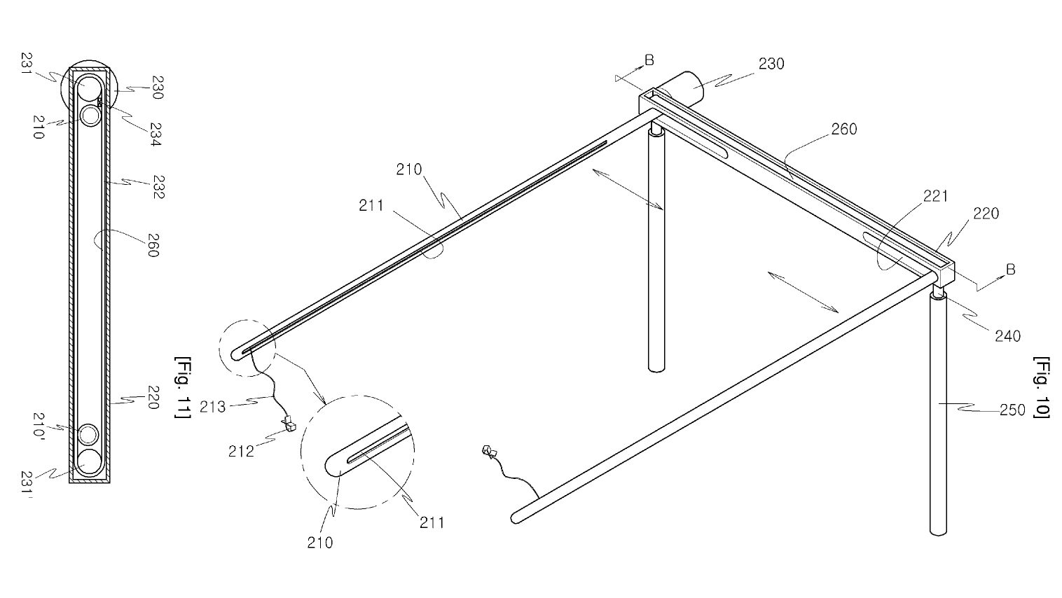

As shown in FIGS. 8 and 9, the wastewater container 341 has double walls formed by two containers.

The wastewater container 341 is comprised of an outer protecting container 341a and an inner creased container 341b. The outer protecting container 341a is made of a metal or plastics which is not contorted or damaged by an external force. A groove 341g is formed on the surface of the outer protecting container.

Further, numbers of wheels are installed on the lower part of the outer protecting container 341a to move the container easily.

The inner creased container 341b installed in the inside of the outer protecting container 341a is provided with an inflow pipe 341d and an outflow pipe 341c, and also provided with a moving plate 341e on one end thereof. A grip 341f is formed on the moving plate 341e, the grip being protruded to the outside through the groove 341g formed on the surface of the outer protecting container

As shown in the figure, the inner creased container 341b has numbers of creases. The inner creased container is shrunk when the container is not filled with a substance, and is extended when the container is filled with a substance. As the inside of the inner creased container is shut from the outside, a bad smell from the substance is prevented from being leaked to the outside.

When the wastewater container 341 is filled with an evacuation, the wastewater container is moved to a place for discharging the evacuation, and then the moving plate 341f formed on one end of the inner creased container 341b is pushed toward the outflow pipe 341c to discharge the evacuation filled in the inner creased container 341b.

That is to say, the evacuation in the inner creased container is discharged by inclining downwardly the outflow pipe 341c, and pushing the grip 341f toward the outflow pipe 341c to shrink the inner creased container 341b.

A water-supply pipe 321, which supplies washing water for flushing the evacuation in the bedpan, is connected to one end of the bedpan 310. The water-supply pipe 321 is normally connected to water supply facilities, and is provided with an electronic valve on the middle thereof to perform automatically water-supply.

The electronic valve(not shown) installed on the water-supply pipe 321 is automatically opened/closed by a sensor(not shown) installed a side of the bedpan 310, the sensor sensing an evacuation. The electronic valve is controlled by the control box 400.

An opening/closing means 330 for opening/shutting the bedpan opening 112a formed in the hip supporting part 112 of the mattress 110 is installed on the upper part of the bedpan 310.

As shown in FIG. 7, the opening/closing means 330 includes a bedpan cover 331 and a driving means for moving the bedpan cover.

A couple of projections 337 are formed on both sides of the bedpan cover 331, respectively, and a hinge rod 336 is formed on an end of the bedpan cover in moving direction. The bedpan cover 331 is moved toward lateral-upward direction or lateral-downward direction by pushing or puling laterally the hinge rod to open/close the bedpan opening 112a formed in the hip supporting part 112.

As shown in FIG. 7, a protrusion is formed on the upper surface of the bedpan cover 331, and is opposed to the bedpan opening 112a formed in the hip supporting part 12 of the mattress 110.

A connecting rod 335 is rotatably connected to the hinge rod 336 formed on the bedpan cover 331. The connecting rod 335 is also rotatably connected to a motor 332.

The motor 332 is a driving source for opening/closing the bedpan cover 331, and is provided with a pinion 333 on a rotating axis thereof.

Teeth formed in the pinion 333 are engaged with teeth formed in a rack 334 under the pinion. When the pinion 333 is rotated by driving the motor 332, the pinion 333 is moved along the rack 334 to move the motor 332, and the connecting rod 335 rotatably coupled to the motor 332 is also moved.

The movement of the connecting rod 335 according to the movement of the motor 332 transfers the bedpan cover 331 laterally.

In order to facilitate the movement of the bedpan cover 331, that is not only horizontal movement of the bedpan cover but also diagonal movement of the bedpan, a guide 338, which guides the projections 337 formed on the both sides of the bedpan 331, is further installed. The guide 338 is provided with guide grooves 338a and 338b thereon, in which the projection 337 is moveable. As shown in figure, the projection in the guide grooves 338a and 338b are moved from the horizon to the diagonal, or vice versa.

As described above, the bed for patient according to the present invention is provided with the disrobing means 200 which help a patient, who is paralyzed from waist down, to get into or put off clothes.

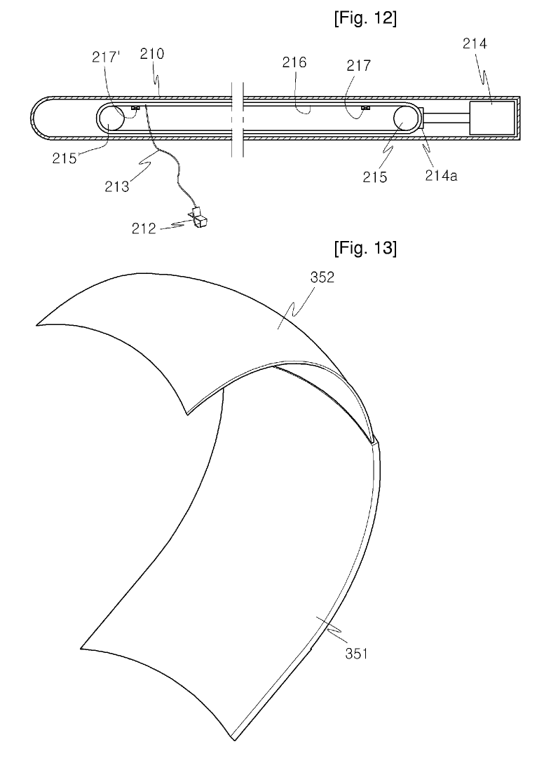

One embodiment of the disrobing means 200 is FIG. 10 FIG. 12.

As shown in figures, the disrobing means 200 includes tongs-shaped trousers hanger 212 shaped for picking up trousers, a trousers hanger transporting frame 210 for moving the trousers hanger 212 along stature direction, and a frame supporting means 220 for moving the trousers hanger transporting frame 210.

The trousers hanger transporting frame 210 is respectively positioned on both end of the mattress supporting frame 130 along the stature direction, and extended from the waist of the patient to the foot.

As cross-sectionally shown in FIG. 10, a trousers hanger moving hole 211 is formed in a portion of the trousers hanger transporting frame 210 toward the mattress, and a motor 214 is installed in the inside of one end portion toward the foot of the patient. The axis of rotation of a bevel gear, which is engaged with the axis of rotation of a bevel gear 214a installed on a shaft of the motor 214, is provided with a pulley 215.

A pulley 215 is installed in the inside of the other end opposed to the one end having the pulley 215. A trousers hanger transporting belt 216 is suspended between the pulleys 215 and 215.

One end of a connection string 213 having the trouser hanger 212 on the other end is fixed to the trousers hanger transporting belt 216. Stop switches 217 and 217, which limit a moving distance of the trousers hanger 212, are installed in a portion of the inside of the trousers hanger transporting frame between the two pulleys 215 and 215. As the connection string 213 is touched to the switches, electricity supplied to the motor 214 is cut off to stop the movement of the motor.

As described above, the trousers hanger transporting frame 210 is supported by the frame supporting means 220. When the frame supporting means 220 supports the trousers hanger transporting frame 210, the trousers hanger transporting frame is supported to move toward a patient lain down the bed. In order for this, a means for moving the trousers hanger transporting frame 210 to the patient is installed in the inside of the frame supporting means 220.

The frame supporting means 220 is constructed as shown in FIG. 11.

The means for moving the trousers hanger transporting frame 210 is formed by suspending a frame transporting belt 260 between two pulleys 231 and 231. The frame transporting belt 260 is rotated by rotating any one of pulleys 231 to move the trousers hanger transporting frame 220 fixed on the frame transporting belt 260.

A means for driving the pulley 231 is the motor 230. The motor 230 is driven by operating control buttons(not shown) on the control box 400.

Further, a movement of the trousers hanger transporting frame 210 is stopped by operation of a stop switch 234 mounted on the inside of the frame supporting means 220.

That is to say, as the trousers hanger transporting frame 210 is enough moved, a portion of the frame transporting belt 260 on which the trousers hanger transporting frame 210 is fixed pushes the stop switch 234 to cut off electricity supplied to the motor 230.

Further, a moving-up and down axis 240 is installed on the lower part of the frame supporting means 220. The moving-up and down axis 240 is inserted in a moving-axis supporting frame 250 fixed on an edge supporting frame 131 to move the frame supporting means 220 up and down.

Namely, as a patient is leaned against and laid on the bed for evacuation to rise, the moving-up and down axis 240 is extracted from the moving-axis supporting frame 250 to raise the frame supporting means 220, thereby raising the trousers hanger transporting frame 210 to prevent the patient from being touched to the trousers hanger transporting frame 210.

A water-supply means 320 is mounted on a side of the bedpan 310.

The water-supply means 310 is for washing the hip and the private parts of the patient after evacuating, and is integral with the shield means.

The first embodiment of the shield means 500 is shown in FIGS. 13 18 in detail.

The shield means 500 in FIG. 13 is the shield means having not a water-supply means. The shield means includes a housing 351 which is hollowed and is arc-shaped in a vertical section and a cross section, and a shielding piece 353 which has the same arc-shape as that of the housing 351 and is installed in the housing.

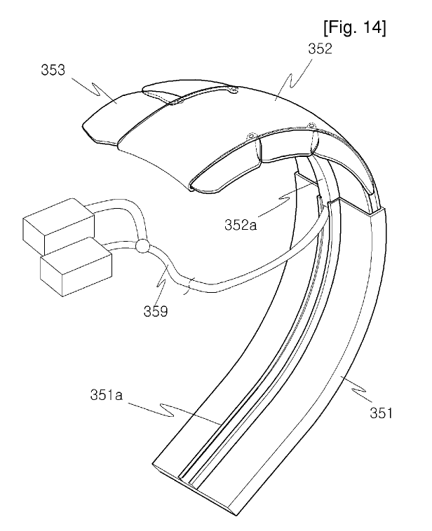

The shielding piece 353 is formed with integral different from a shielding piece in FIG. 14. As shown in FIG. 13, the shielding piece 353 shields around the private parts when extracted from the housing 351 because the shielding piece is arc-shaped in the vertical section and the cross section.

The second embodiment of the shield means 500 is shown in FIG. 14. The shield means includes the housing 351 enclosing each of elements, a shielding piece housing 352 having shielding pieces 353 for shielding the private parts therein, a shielding piece driving means 358 for extending the pieces 353, and a moving means 356 for extracting the shielding piece housing 352 from the housing 351.

As shown in FIGS. 3 and 4, the housing 351 is fixed to a side of the mattress supporting frame 130 through a housing fixing frame 370, and is rotated with its hinge point as the central figure by operation of a spring shock absorber 360. The housing is formed as a tube-type with an arc shape. As shown in FIG. 14, an insertion groove 351a for a water-supply pipe is formed on an inner side of the arc shape. As will be seen from FIGS. 14 to 16, an arc-shaped rack 351b is installed on the inside of the housing, and a pinion 354a mounted on the axis of rotation of a D.C. motor 354 is engaged with the rack 351b.

The inside of one end of the housing 351, that is, the inside of the end opposing to the shielding piece housing 352 is provided with a step, and a housing step 352b formed on the shielding piece housing 352 is caught by the step in the housing 352.

As described above, the shielding piece housing 352 is installed in the inside of the housing 351 to freely come in and out the housing 351.

The shielding piece housing 352 includes two arc-shaped plates, and each of the plates has curvature for inserting into the inside of the housing 351. The end of the shielding piece housing toward the housing 351 has the housing step 352b which is caught by the step formed on the housing 351. A water-supply pipe insertion part 352a, which has numbers of passing-through holes and is opposed to the insertion groove for water-supply pipe 351a formed in the housing 351, is formed on the housing 352 with integral.

As shown in FIG. 14, the insertion groove for water-supply pipe 351a has a portion which is incised towards the exterior, and is formed such that the water-supply pipe insertion part 352a formed on the shielding piece housing 352 is moveable along the insertion groove for water-supply pipe 351a with being inserted into the insertion groove for water-supply pipe 351a.

So to speak, a hose 352d inserted in the water-supply pipe insertion part 352a formed on the shielding piece housing 352 is moveable along the portion, incised toward the exterior, of the insertion groove for water-supply pipe 351a. In order for movement of the hose 352d, the hose is made of soft plastics.

The shielding piece 353 is hinge-fixed to a hinge-projection 353a formed on both sides of the shielding piece housing 352, and is normally in a folded state toward the center of the housing 352 by means of a spring 353b. A rotating projection part 353c is formed on the hinge-fixed portion.

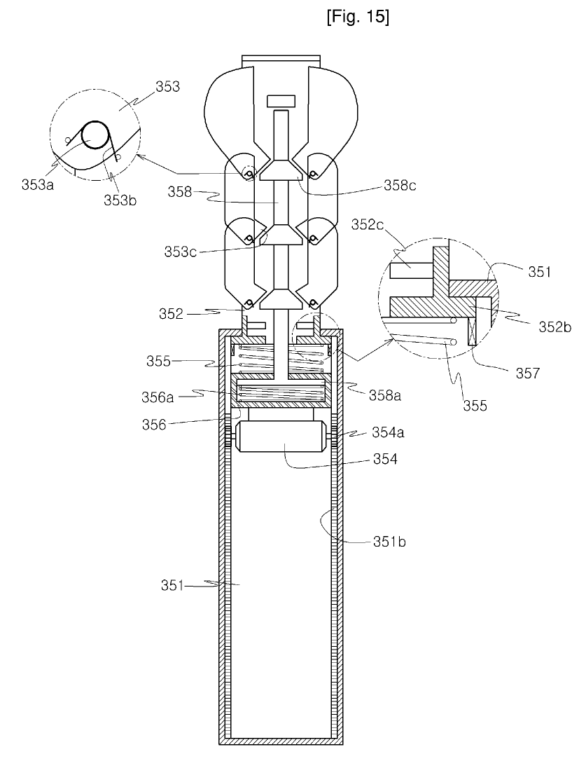

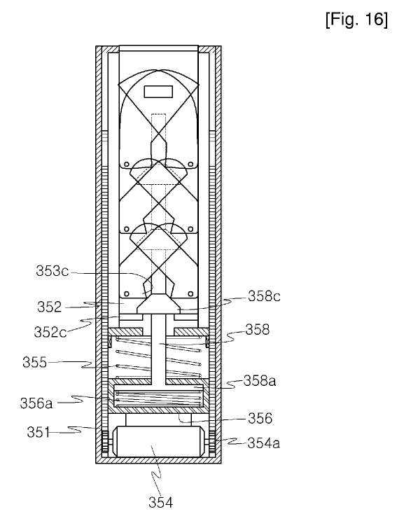

Namely, as shown in FIG. 16, when the shielding piece housing 352 is in the housing 351, the shielding piece 353 is inserted in the shielding piece housing 352 to be hidden. As shown in FIG. 15, when the shielding piece housing 352 is out of the housing 351, the shielding piece 353 is spread out from the shielding piece housing 352 to shield the hip and the private parts of patient.

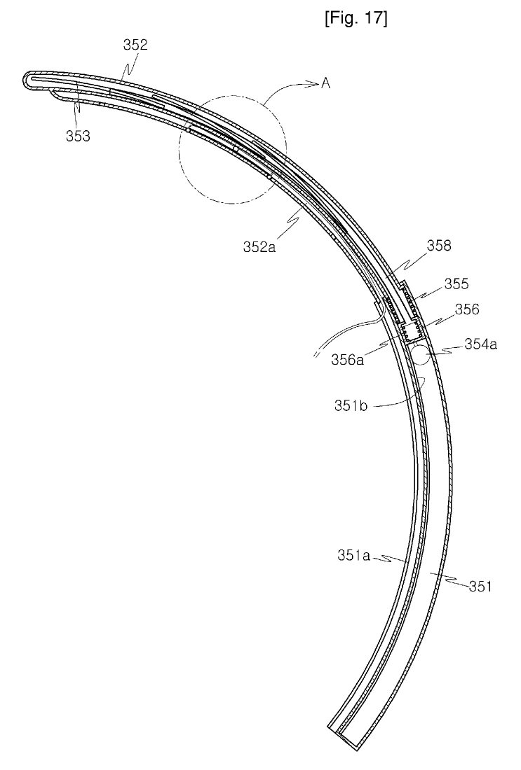

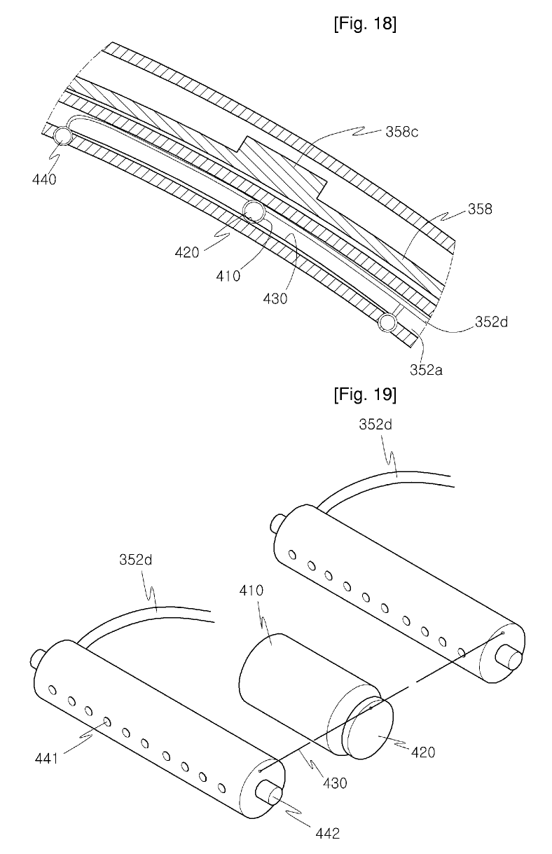

As will be seen from FIGS. 17 and 18, the passing-through hole formed on the water-supply pipe insertion part 352a is formed as a cylinder-type and has numbers of holes formed thereon. An injection nozzle 440 is formed on the holes.

The hose 352d in the water-supply pipe insertion part 352a is connected to one end of the injection nozzle 440, and the injection nozzle 440 is rotatably installed by a rotating axis 442. A means for controlling a direction of injected air and water is further provided. The direction of the injected air and water is controlled by repeatedly rotating the injection nozzle 440 to change a direction of an injection hole 441.

The means for controlling the direction of injected air and water is formed by installing an eccentric pulley 420 on the axis of rotation of a D.C. motor 410, and connecting a wire 430 to a side of the cylindrical injection nozzle 440. Therefore, the means for controlling the direction of injected air and water is rotated, as the eccentric pulley 420 is rotated by the D.C. motor.

The D.C. motor 354, the pinion 354a and the rack 351b are provided as a means for pushing or drawing the shielding piece housing 352 into or from the housing 351.

The moving means 356 is installed on a circumference of the D.C. motor 354. As shown in FIGS. 15 and 16, the moving means 356 is installed in the housing 351, and is moved by operation of the motor 354 in the housing.

That is, when the pinion 354a installed on the axis of rotation of the D.C. motor 354 is rotated by operation of the motor 354, the motor 354 is moved as the pinion is engaged with the rack 351b fixed on the inside of the housing 352. Thus, the moving means 356 is transferred to move the driving plate 358 connected to a side of the moving means 356.

A second shock-absorbing spring 356a is installed on the inside of the moving means 356.

As described above, one end of the shielding piece driving plate 358 is inserted in the moving means 356. The shielding piece driving plate 358 pushes the rotating projection part 353c formed on a side of the shielding piece 353 to rotate the shielding piece 353 with the hinge axis 353a as the central figure. Thus, the shielding piece 353 is exposed from the shielding piece housing 352 as shown in FIG. 15a.

The shielding piece driving plate 358 is shaped as a plate-type, and provided with a shielding-piece rotating means 358c on both sides thereof. The shielding piece driving plate pushes the rotating projection part 353c formed on the hinge-fixed portion of the shielding piece 353 to spread out the shielding piece 353 from the shielding piece housing 352. One end of the shielding piece driving plate 358 is inserted into the moving means 356 to be elastically supported by the second shock-absorbing spring 356a.

A first shock-absorbing spring 355 is further installed between the moving means 356 and the end of the shielding piece housing 352 inserted in the housing 351.

As the first shock-absorbing spring 355 is shrunk when the shielding piece housing 352 is caught by a part of patient body or a sheet, one end of the moving means 356 pushes a stop switch 357 installed on the housing 351 to stop the D.C. motor 354. Thereby, the patient is not irritated by the shielding piece housing 352.

As shown in FIGS. 2 and 3, when the housing 351 is fixed by the housing fixing frame 370, the upper part of the housing is hinge-connected and the lower part is connected to the spring shock absorber 360. Thus, if the shielding means spread out from the housing 351 is pressed by a sheet, etc. or the height of the shielding means is too high, the lower part of the housing is pulled or pressed by the spring shock absorber 360 through pushing the shielding means to adjust the height of the shielding means.

Even though a manner for controlling electronic devices described above, that is, the manner for controlling motors and stop switches for controlling electricity supplied to the motors is not shown, it is easily understood that the manner for controlling can be accomplished by a contact switch for controlling the flow of electricity, and a software control for automatically controlling the contact switch. Moreover, this kind of controlling is performed by a control box having a microcomputer therein.

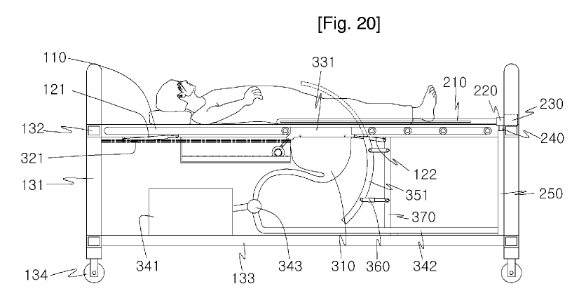

Further, as shown in FIG. 20, as the bed for patient according to the present invention is operated between the legs of the patient with the patient lying down, and the shielding piece 353 to hide the hip and private parts of patient, a disabled patient can pass urine with lying down. At this time, the shielding piece 353 and the shielding piece housing 352 can prevent the patients urine from being splashed to the outside.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

1. A bed for patient including a bedpan means 300 installed on the under part of a bedstead 100 supporting a mattress, the bed comprising:
a bedpan opening 112a formed on the upper part of the mattress in which the bedpan means 300 is installed; and
a shield means 500 installed on a side of the bedpan opening 112a, said shield means shielding the hip and private parts of human body.

2. The bed for patient as claimed in claim 1, wherein the shield means 500 comprises:
a housing 351 which is hollowed, and is arc-shaped in a vertical section and a cross section; and
a shielding piece 353 which has the same arc-shape as that of the housing 351, and is installed in the housing.

3. The bed for patient as claimed in claim 2, wherein shield means 500 comprises:
a housing 351 which is fixed to a side of a mattress supporting frame 130 through a housing fixing frame 370, and is rotated with its hinge point as the central figure by operation of a spring shock absorber 360, the housing being formed as a tube-type with an arc shape, an insertion groove for a water-supply pipe 351a being formed on an inner side of the arc shape, an arc-shaped rack 351b being installed on the inside of the housing, and a pinion 354a mounted on the axis of rotation of a D.C. motor 354 being engaged with the rack 351b;
a shield piece housing 352 which includes two arc-shaped plates, each of the plate having curvature for inserting into the inside of the housing 351, an end of the shielding piece housing toward the housing being provided with a housing stop-step 352b which is caught by a step formed on the housing 351, and a water-supply pipe insertion part 352a, which has numbers of passing-through holes and is opposed to the insertion groove for water-supply pipe 351a, being formed on the housing 352 with integral;
numbers of shielding pieces 353, which are hinge-fixed to hinge-projections 353a formed on both sides of the shielding piece housing 352 and are normally in a folded state toward the center of the housing 352 by means of a spring 353b, an rotating projection part 353c being formed on the hinge-fixed portion;
a moving means 356, which is installed in the housing 351 and connected to one end of a D.C. motor 354, the moving means 356 being moved along the rack 351b by operation of the motor 354 in the housing, and being provided with a second shock-absorbing spring 356a therein;
a shielding piece driving plate 358, which is shaped as a plate-type and is provided with a shielding-piece rotating means 358c on both sides thereof, the shielding piece driving plate pushing the rotating projection part 353c formed on the hinge-fixed portion of the shielding piece 353 to spread out the shielding piece 353 from the shielding piece housing 352, one end of the shielding piece driving plate 358 being inserted into the moving means 356 to be elastically supported by the second shock-absorbing spring 356a; and
a first shock-absorbing spring 355 installed between the moving means 356 and the end of the shielding piece housing 352 inserted in the housing 351.

4. The bed for patient as claimed in claim 3, wherein the hole formed on the water-supply pipe insertion part 352a is provided with an injection nozzle 440, the injection nozzle 440 is shaped as a cylindrical type and formed with numbers of injection holes 441, one end of the injection nozzle is connected to a hose 352d to be supplied with air or water, and a means for controlling a direction of injected air and water by repeatedly rotating the injection nozzle 440 is further provided,
the means for controlling a direction of injected air and water being formed by installing an eccentric pulley 420 on the axis of rotation of a D.C. motor 410, and connecting a wire 430 to a side of the cylindrical injection nozzle 440.

5. The bed for patient as claimed in any one of claims 1 and 2, wherein the bedstead 100 includes a mattress 110 which has a back part 111, a hip supporting part 112, a leg supporting part 113 and a foot supporting part 114, all of the parts being foldably hinge-joined, a mattress supporting frame 130 formed by supporting a horizontal frame 132 and a vertical frame 133 with a edge supporting frame 132, and a mattress folding means 120 for folding or spreading the mattress 110;
The back part 111 and the hip supporting part 112 of the mattress 110 are hinge-fixed to the middle of the mattress supporting frame 130 by a fixed hinge axis 111a to rotate with the fixed hinge axis 111a as the central figure, portions between the hip supporting part 112 and the leg supporting part 113, and the leg supporting part 113 and the foot supporting part 114 are foldable through folding means 112b and 114a, and moveable hinge axes 113a and 114b are installed on the middle of the leg supporting part 113 and one end of the foot supporting part 114, respectively, the moveable hinge axes 113a and 114b being laterally moved in the inside of an axis moving groove 133a formed in the inside of the vertical frame 133 of the mattress supporting frame 130; and
the mattress folding means 120 includes:
a first cylinder 121, one end of the first cylinder being hinge-connected to the mattress supporting frame 130, one end of a piston axis in the first cylinder being hinge-connected to the back part 111 of the mattress to push or pull the back part 111 with the fixed hinge axis 111a as the central figure; and
a second cylinder 122, one end of the second cylinder being hinge-connected to the mattress supporting frame 130, one end of a piston axis in the second cylinder being hinge-connected to the hip supporting part 112 to push or pull the hip supporting part 112 with the fixed hinge axis 111a as the central figure.

6. The bed for patient as claimed in any one of claims 1 3, wherein the bedpan means 300 includes:
a bedpan 310 installed under the bedpan opening 112a formed on the center of the hip supporting part 112 in the mattress 110; a water-supply means 320 for supplying water for washing the hip and the private parts of the patient after evacuating; a discharging means 340 for discharging the evacuation and wastewater in the bedpan; and an opening/closing means 330 for opening/shutting the bedpan opening 112a;
the opening/closing means 330 includes:
a bedpan cover 331 for opening/shutting the bedpan opening 112a formed on the center of the hip supporting part 112, the bedpan cover being formed as plate type and provided with a couple of projections 337 formed on both sides thereof, respectively, and an end of the bedpan cover in moving direction being formed with a hinge rod 336;
a guide 338 formed with guide grooves 338a and 338b thereon, a projections 337 formed on the both sides of the bedpan 331 being slidably inserted in the grooves;
a motor 332 provided with a pinion 333 on a rotating axis thereof, a connecting rod 335 rotatably being coupled to a hinge rod 336 formed on an end of the bedpan cover 331; and
a rack 334 having teeth formed in the pinion 333, the motor 332 being reciprocated on the rack 334 according to a rotation of pinion 333 as the motor is operated.

7. The bed for patient as claimed in any one of claims 1 3, wherein a disrobing means 200 which help a patient, who is paralyzed from waist down, to get into or put off clothes is further provided to the bedstead 100,
the disrobing means 200 includes: a trousers hanger transporting frame 210 which is respectively positioned on both end of the mattress supporting frame 130 along the stature direction and extended from the waist of the patient to the foot, a trousers hanger moving hole 211 being formed in a portion of the trousers hanger transporting frame 210 toward the mattress, a motor 214 is installed in the inside of one end portion toward the foot of the patient, the axis of rotation of a bevel gear, which is engaged with the axis of rotation of a bevel gear 214a installed on a shaft of the motor 214, being provided with a pulley 215, and a pulley 215 being installed in the inside of the other end opposed to the one end having the pulley 215; a frame supporting means 220 which is formed with a transporting frame hole 221 on a portion thereof toward the mattress, and is provided with a frame transporting belt 260 suspended between two pulleys 231 and 231 therein, the trousers hanger transporting frame 210 being fixed to both side of the middle of the frame transporting belt 260; and a motor 230 installed on any one of the pulleys mounted in the inside of the frame supporting means 220;
a moving-up and down axis 240 is further installed on the lower part of the frame supporting means 220, the moving-up and down axis 240 being inserted in a moving-axis supporting frame 250 fixed on an edge supporting frame 131 to move the frame supporting means 220 up and down.

8. The bed for patient as claimed in claim 6, wherein the discharging means 340 for discharging the evacuation and wastewater in the bedpan is formed by connecting one port of a 3-way valve 343 to a drainpipe connected to the lower part of the bedpan 310, and connecting the remaining two ports to two pipes, one connected to a wastewater container 341 and the other 342 connected to an outfall.

9. The bed for patient as claimed in claim 8, wherein the wastewater container 341 includes:
an outer protecting container 341a formed with a groove 341g on the surface thereof;
an inner creased container 341b which is installed in the inside of the outer protecting container 341a and is provided with an inflow pipe 341d in an upper part and an outflow pipe 341c in a side part; and
a moving plate 341e which is installed on one end of the inner creased container 341b and formed with a grip 341f, the grip being protruded to the outside through the groove 341g formed on the surface of the outer protecting container 341a.
